(19) United States
(12) Patent Application Publication
(10) Pub. No.: US 2017/0197162 A1
(43) Pub. Date: Jul. 13, 2017

(54) FILTER CARTRIDGE HAVING SEPARABLE FILTER COMPONENTS

(71) Applicant: Cummins Filtration IP, Inc., Columbus, IN (US)

(72) Inventors: Wassem Abdalla, Cookeville, IN (US); Stéphane LeGuyader, Briec (FR); Stéphane Simon, Guengat (FR)

(73) Assignee: Cummins Filtration IP, Inc., Columbus, IN (US)

(21) Appl. No.: 15/325,404

(22) PCT Filed: Jul. 21, 2015
(86) PCT No.: PCT/US15/41286

§ 371 Date: Jan. 10, 2017

(30) Foreign Application Priority Data
Jul. 28, 2014 (FR) 1457288

(51) Int. Cl. B01D 35/153; F02M 37/22; B01D 36/00; B01D 29/15; B01D 29/58

(52) U.S. Cl. CPC B01D 35/153; B01D 29/15; B01D 29/58; B01D 36/003; F02M 37/22; B01D 2201/305; B01D 2201/291

(57) ABSTRACT

No-filter no-run filtration systems are described. The filtration systems include a valve positioned within a filter housing. The valve is normally biased in a closed position when a filter cartridge is not inserted into the filter housing such that from within the filter housing cannot flow to an internal combustion engine. The filter cartridge includes a main filter element and a hydrophobic screen assembly. The hydrophobic screen assembly includes a valve interaction pin that interacts with and opens the valve when the hydrophobic screen assembly is received in the filter housing in an operating position. Accordingly, fuel can only flow from the filter housing to the fuel injectors when the hydrophobic screen is received within the housing in an operating position. The hydrophobic screen is a separate component from the main filter element allowing for independent replacement of the main filter element and the hydrophobic screen.

### CROSS-REFERENCE TO RELATED APPLICATION

The present application claims the benefit of and priority to French Patent Application No. 1457288, filed Jul. 28, 2014, which is incorporated herein by reference in its entirety.

### TECHNICAL FIELD

The present disclosure relates to filtration systems.

### BACKGROUND

Internal combustion engines combust fuel (e.g., diesel fuel, gasoline, ethanol, etc.) to power or drive a component, such as a vehicle. Contaminants, such as water, dust, and other particulate matter, can damage the internal combustion engine if the contaminants are not removed prior to combustion. Accordingly, certain standard levels of fuel cleanliness are often required by the internal combustion engine in order to ensure the life of the engine, to prevent degradation of performance, and to ensure proper emissions standards are met. Many internal combustion engines rely on fuel filtration systems to provide clean and substantially water-free fuel to the internal combustion engine and its components (e.g., the fuel injectors). The fuel filtration systems generally include a filter element that filters particulate (e.g., dust and debris) from the fuel and separates dispersed water that may be contained in the fuel for later draining.

The filter elements of the fuel filtration systems typically have a limited life. As fuel is processed through a filter element, the filter element captures particulate contaminants and continues to do so until the restriction of the filter element reaches a threshold value (i.e., the restriction becomes too large for the fuel filtration system to efficiently provide clean fuel to the internal combustion engine). Accordingly, the filter elements are periodically replaced with replacement filter elements. As a cost saving measure, some internal combustion engine operators and servicers replace original filter elements with non-genuine replacement filter elements (e.g., off-brand or used filter elements that are not certified to provide filtered fuel according to the standard cleanliness levels). Additionally, some operators and services simply remove the original filter element when the original filter element become clogged and attempt to run the internal combustion engine without a replacement filter element. In each situation, the fuel delivered to the internal combustion engine may not meet the required fuel cleanliness standard and may cause damage to the internal combustion engine or negatively impact the environment (e.g., increase emissions levels). Still further, multi-stage filter cartridges are often wholly discarded and replaced despite certain stages having a longer lifespan than the other stages resulting in unnecessary replacement of the certain stages.

### SUMMARY

One embodiment relates to a filtration system for filtering a fluid and providing the filtered fluid to a component of an internal combustion engine. The filtration system includes a housing and a standpipe having a valve, the valve being biased towards a closed position that prevents the flow of fluid through the valve. A filter cartridge is removably received within the housing, the filter cartridge including a primary filter element and a screen assembly. The primary filter element includes a filter media for filtering the fluid, a first endcap, and a second endcap. The screen assembly includes a screen portion and an endcap portion. The endcap portion includes a valve interaction pin that interacts with the valve to open the valve and allow the fluid to flow through the valve when the filter cartridge is in an operating position within the housing. The valve interaction pin can also be formed as part of the screen, or it can be a stand-alone component.

These and other features, together with the organization and manner of operation thereof, will become apparent from the following detailed description when taken in conjunction with the accompanying drawings.

### BRIEF DESCRIPTION OF THE FIGURES

FIG. 1 is a cross-sectional view of a filtration system according to an exemplary embodiment.

FIG. 2 is an exploded cross-sectional view of the filter cartridge of FIG. 1.

FIG. 3 is a close-up cross-sectional view of the screen assembly of the filter cartridge of FIG. 1.

FIG. 4 is a close-up cross-sectional view of the filtration system of FIG. 1 having the filter cartridge inserted into the housing in the operating position.

FIG. 5 is a close-up cross-sectional view of the valve of the filtration system of FIG. 1 having the filter cartridge inserted into the housing in the operating position.

FIG. 6 is a cross-sectional view of a filtration system according to an exemplary embodiment.

### DETAILED DESCRIPTION

Referring to the figures generally, no-filter no-run filtration systems are described. The filtration systems include a valve positioned within a filter housing. The valve is normally biased in a open position when a filter cartridge is not inserted into the filter housing, unless there is a flow of fluid, in which case the fluid moves the valve to the closed position. When the valve is in the closed position, fuel from within the filter housing cannot flow to the fuel injectors of the internal combustion engine. The filter cartridge includes a main filter element and a hydrophobic screen assembly. The hydrophobic screen assembly includes a valve interaction pin that interacts with and opens the valve when the hydrophobic screen assembly is received in the filter housing in an operating position. Accordingly, fuel can only flow from the filter housing to the fuel injectors when the hydrophobic screen is received within the housing in an operating position. The hydrophobic screen is a separate component from the main filter element allowing for independent replacement of the main filter element and the hydrophobic screen.

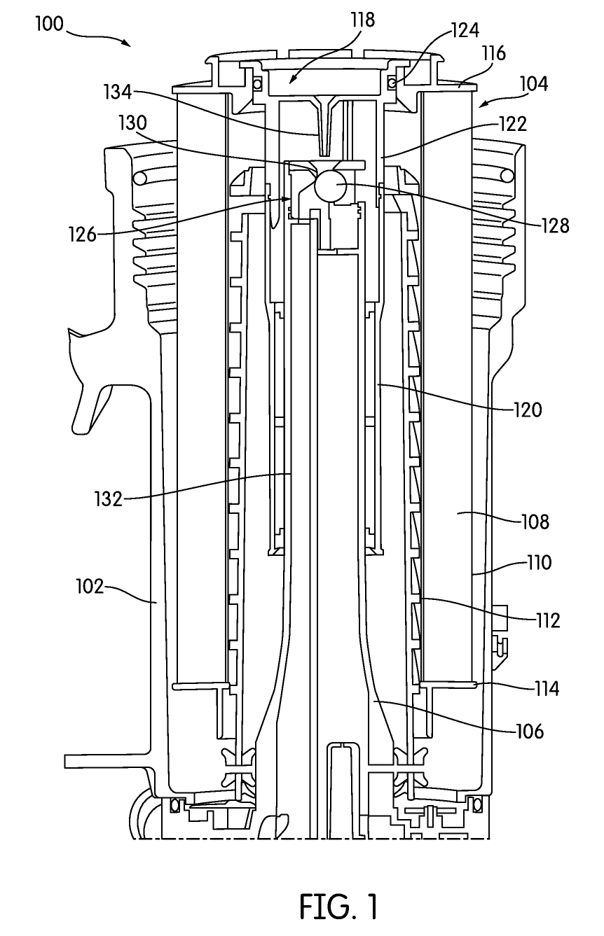

A cross-sectional view of a filtration system 100 according to an exemplary embodiment is shown in FIG. 1. The filtration system 100 includes a lower shell 102 of a filter housing. The filtration system 100 further includes a removable filter cartridge 104 removably received within the housing. In the embodiment depicted in FIG. 1, the filter cartridge 104 is substantially cylindrical in shape. As shown in FIG. 1, the filter cartridge 104 is partially inserted into the lower shell 102 over a standpipe 106. The filter cartridge 104 includes a primary filter element 108. The primary filter element 108 includes a filter media (e.g., a paper-based filter media, a foam-based filter media, a cotton-based filter media, a pleated filter media, etc.) that filters a liquid such as fuel. The primary filter element 108 includes a dirty side 110 and a clean side 112. The dirty side 110 receives liquid to be filtered, and the clean side 112 outputs filtered liquid. A first end of the filter media is secured by a first endcap 114, and a second end of the filter media is secured by a second endcap 116. Both the first endcap 114 and the second endcap 116 are open.

The filter cartridge 104 further includes a removable screen assembly 118. The screen assembly 118 includes a screen 120. The screen 120 is a hydrophobic screen. The screen 120 captures, coalesces, and drains water remaining in the fuel after the fuel has been passed through the primary filter element 108. In the embodiment of FIG. 1, the screen 120 is substantially cylindrical in shape such that it can be inserted over the standpipe 106 and inside of the primary filter element 108. The screen 120 can also be a stand-alone component. Accordingly, the screen 120 is positioned on the clean side 112 of the primary filter element 108. The screen assembly 118 is positioned inside of an opening formed within the primary filter element 108, and the standpipe 106 is positioned within an opening formed within the screen assembly 118 when the filter cartridge 104 is in the operating position (i.e., the primary filter element 108, the screen assembly 118, and the standpipe 106 are positioned in a nesting relationship when the filter cartridge 104 is in the operating position).

The screen assembly 118 includes an endcap portion 122. In some arrangements, the endcap portion 122 is secured to the screen 120 through a snap-fit connection. In other arrangements, the endcap portion 122 is integral with the screen 120. The screen assembly 118 is removably received within the filter cartridge 104. The endcap portion 122 removably connects to the second endcap 116 of the primary filter element 108. The connection between the endcap portion 122 and the second endcap 116 may be formed by a snap-fit connection, a press-fit connection, a friction-fit connection, or the like. A seal 124 may be positioned between the endcap portion 122 and the second endcap 116 to seal the dirty side 110 from the clean side 112.

Still referring to FIG. 1, the filtration system 100 includes a valve 126. The valve 126 is a no-filter no-run valve. The valve 126 is positioned on an end of the standpipe 106. The valve 126 includes a ball 128 that is biased towards an orifice 130 of the valve 126. The ball 128 is sized and shaped to seal the orifice 130. Accordingly, the valve 126 is biased towards the closed position (i.e., the ball 128 blocks fluid from flowing through the orifice 130) that prevents the flow of fluid through the valve 126. The orifice 130 leads to a fuel supply line 132 that provides filtered fuel from the filtration system 100 to a component an internal combustion engine, such as a fuel injector. When the valve is in the closed position, fuel is prevented from flowing from the filter housing to the internal combustion engine. The endcap portion 122 of the screen assembly 118 includes a valve interaction pin 134. As described in further detail below, when the filter cartridge 104 is fully inserted in the housing and is in an operating position within the housing, the valve interaction pin 134 pushes the ball 128 away from the orifice 130, thereby opening the valve 126 and allowing fuel to flow through the fuel supply line 132.

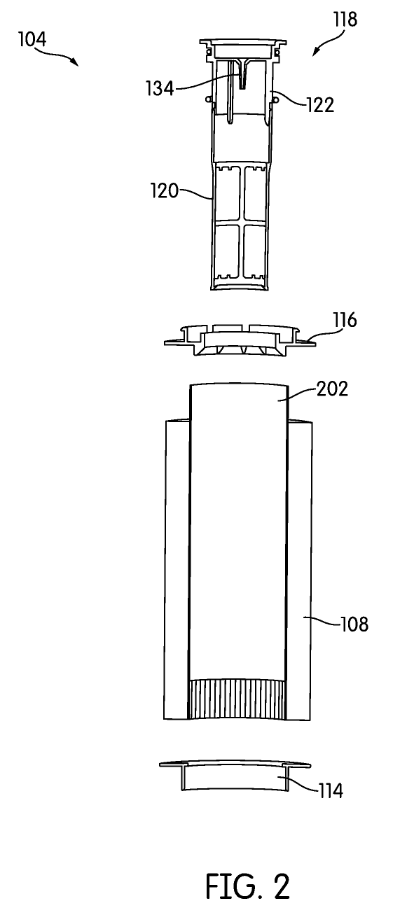

FIG. 2 is an exploded cross-sectional view of the filter cartridge 104. The filter cartridge 104 includes the primary filter element 108 having the first endcap 114 and the second endcap 116. In some arrangements, the primary filter element is supported by a support member 202. The support member 202 adds rigidity to the primary filter element 108 such that the primary filter element 108 will not collapse under the pressure of the fluid filtered through the primary filter element 108. The filter cartridge 104 also includes the removable screen assembly 118. The removable screen assembly includes a screen 120 and an endcap portion 122. The endcap portion 122 includes the valve interaction pin 134. As discussed above, the primary filter element 108 and the screen assembly 118 are independently replaceable.

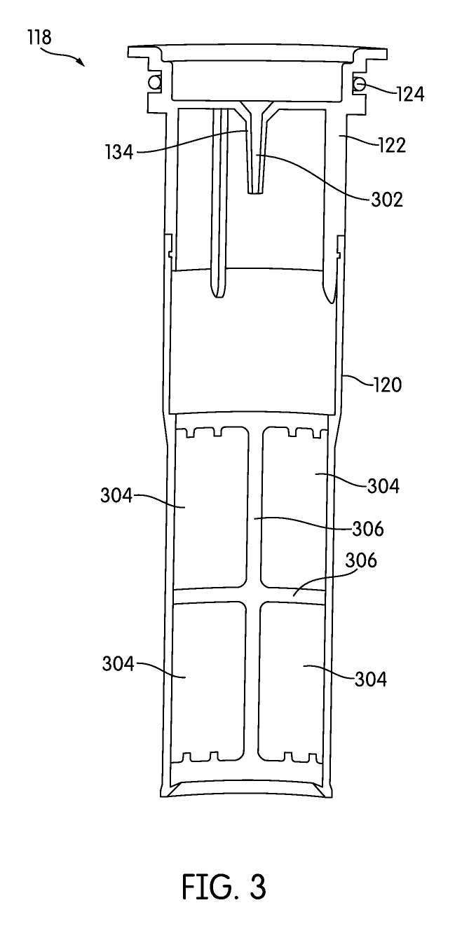

A close-up cross-sectional view of the screen assembly 118 is shown in FIG. 3. As previously discussed, the screen assembly includes the screen 120 and the endcap portion 122. The endcap portion 122 includes a valve interaction pin 134. Additionally, a seal 124 may be positioned around the endcap portion 122 to seal the endcap portion to the second endcap 116 of the filter cartridge 104. As shown in FIG. 3, the valve interaction pin 134 is hollow and includes a passage 302 there through from an inside portion of the endcap portion 122 to an outside portion of the endcap portion 122. The screen 120 includes a plurality of screen panels 304 supported by support members 306. Each screen panel 304 includes a screen mesh of a hydrophobic screen material. In an alternative arrangement, a single screen panel is wrapped around the screen 120 and supported by the support members 306.

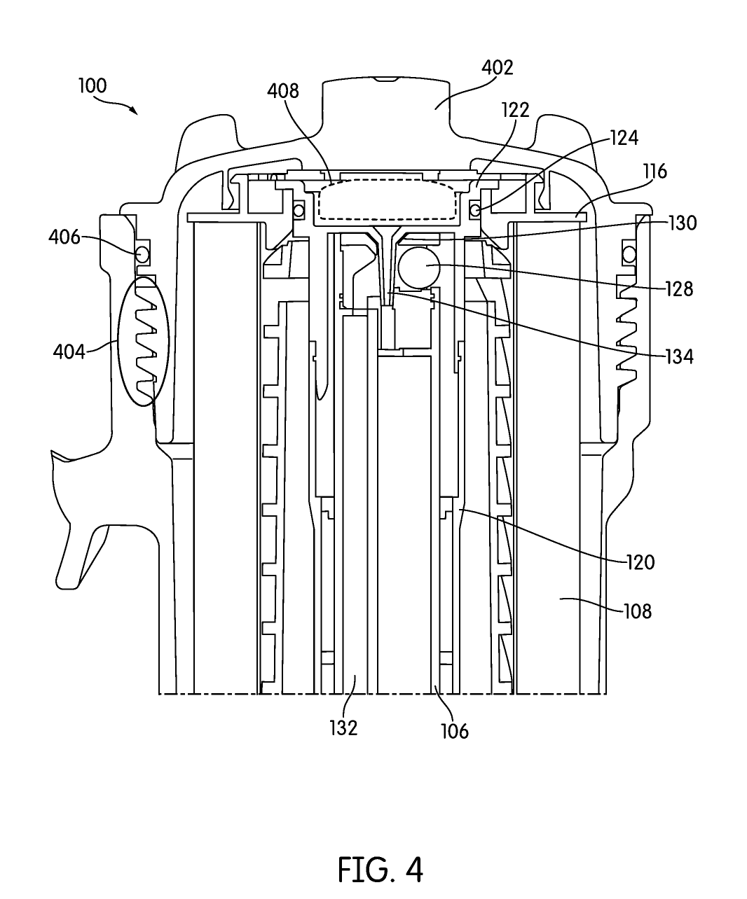

Referring to FIG. 4, a close-up cross-sectional view of the filtration system 100 having the filter cartridge 104 inserted into the housing in the operating position is shown. When the filter cartridge 104 is inserted into housing (comprised of bottom shell 102 and top shell 402), the valve interaction pin 134 extends through the orifice 130 and pushes the ball 128 away from the orifice 130 thereby opening the valve 126. When the valve 126 is open, filtered fuel is able to flow through the fuel supply line 132. A top shell 402 of the housing secures the filter cartridge in the operating position. The top shell 402 attaches to the bottom shell 102 through a mating threaded connection 404. A seal 406 may be positioned between the top shell 402 and the bottom shell 102.

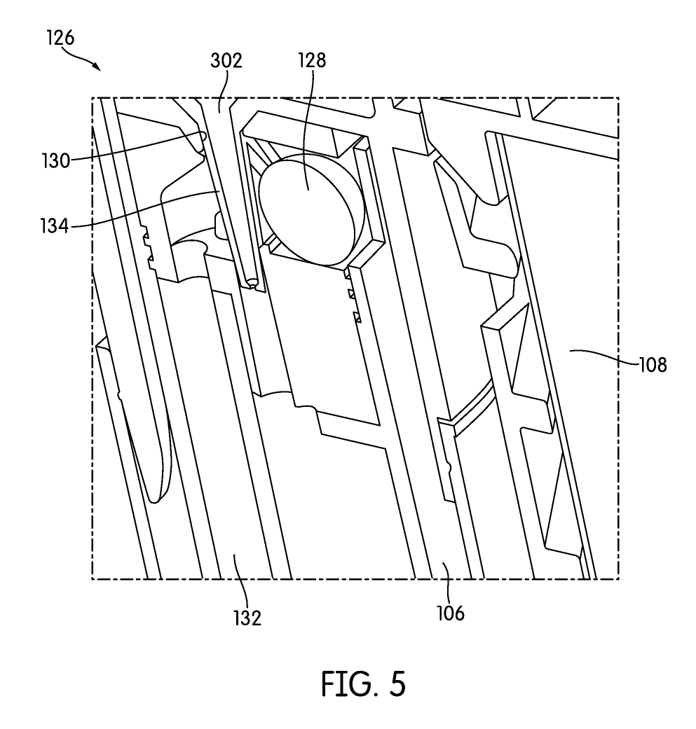

As seen in the close-up cross-sectional view of the valve 126 with the filter cartridge 104 inserted into the housing in the operating position in FIG. 5, the valve interaction pin 134 is inserted into the orifice 130 and into an opening 502. The a tip portion of valve interaction pin 134 is sized and shaped to seal the opening 502. The passage 302 of the valve interaction pin 134 opens into the opening 502. The opening 502 leads back to the fuel tank that supplies fuel to be filtered to the filtration system 100. The passage 302 in the valve interaction pin 134 and the opening 502 allows air trapped between the top shell 402 and the second endplate 116 to be vented from the housing back into the fuel tank. The trapped air may be removed from the fuel during the filtering process or trapped when the top shell 402 is removed and attached (e.g., during a filter cartridge servicing operation).

As described above, fuel only flows from the housing through the fuel supply line 132 when the valve interaction pin 134 opens the valve 126. The valve interaction pin 134 only opens the valve 126 when the screen assembly 118 is positioned in an operational position within the housing. Accordingly, fuel flows when the screen assembly 118 having the valve interaction pin 134 is in the installed position. The screen assembly 118 can only be in the installed position when the screen assembly 118 is installed into the filter cartridge 104, and the filter cartridge 104 is fully installed in the operational position within the housing. Accordingly, the positioning of the valve interaction pin 134 on the screen assembly 118 ensures that both filtration components (the screen assembly 118 and the primary filter element 108) are present. This prevents the internal combustion engine and its components, such as the fuel injectors, from receiving dirty fuel. Further, the multicomponent design of the filtration cartridge 104 having the separable primary filter element 108 and screen assembly 118 helps ensure that the appropriate filter cartridge components are used during service operations. If an improper component is used, fuel may not flow from the filtration system 100 to the internal combustion engine, thereby preventing potentially dirty fuel from entering the internal combustion engine.

Further, the screen assembly 118 may have a different lifespan than the primary filter element 108. Because the screen assembly 118 is a separate, stand-alone unit, the screen assembly 118 and the primary filter element 108 can be replaced independent of each other. For example, if the screen assembly 118 is designed to have a longer filtering lifespan than the primary filter element 108, an operator of the internal combustion engine can independently replace the primary filter element 108 multiple times before having to replace the screen assembly 118. Such an arrangement reduces the costs of replacement parts because customers only need to purchase one of the screen assembly 118 and the primary filter element 108, not both at the same time in arrangements where the screen assembly 118 and the primary filter element 108 are integrated. Additionally, such an arrangement reduces unnecessary waste, as both the primary filter element 108 and the screen assembly 118 can each be independently replaced based on their individual filtering capacities (e.g., their individual maximum contamination levels).

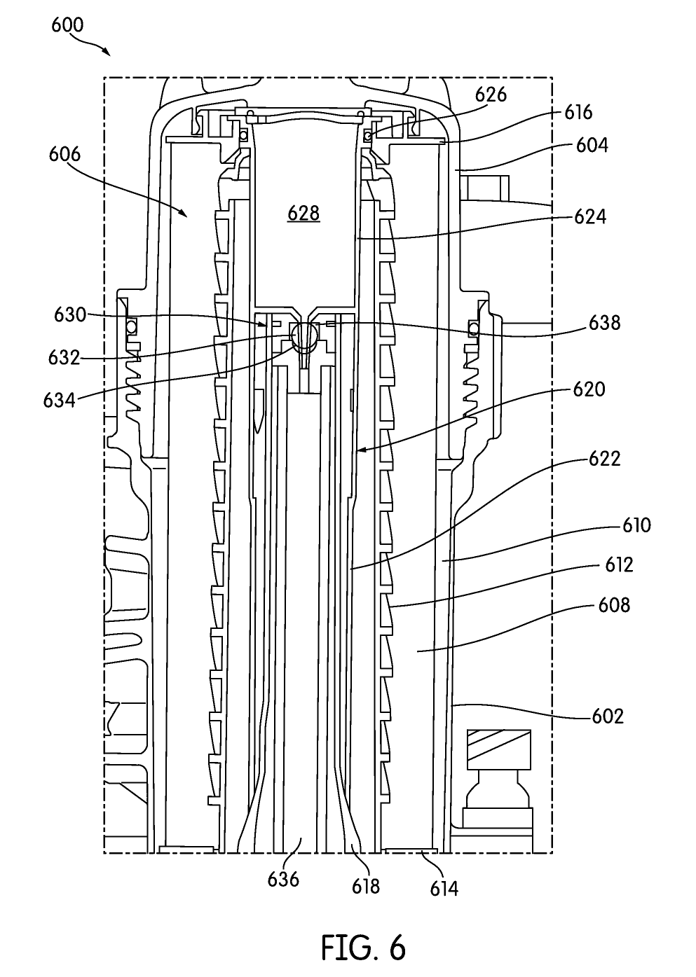

Referring to FIG. 6, a cross-sectional view of a filtration system 600 is shown according to another exemplary embodiment. The filtration system 600 includes a housing comprised of a lower housing shell 602 and an upper housing shell 604. The filtration system 600 includes a removable filter cartridge 606 removably received within the housing. The filter cartridge 606 is similar to the filter cartridge 104 of system 100. The filter cartridge 606 is substantially cylindrical in shape and includes a primary filter element 608 having a filter media (e.g., a paper-based filter media, a foam-based filter media, a cotton-based filter media, a pleated filter media, etc.) that filters a liquid, such as fuel. The primary filter element 108 includes a dirty side 610 and a clean side 612. The dirty side 610 receives liquid to be filtered and the clean side 612 outputs filtered liquid. A first end of the filter media is secured by a first endcap 614, and a second end of the filter media is secured by a second endcap 616. The first endcap 614 is open. In some arrangements, the second endcap 616 is open. In other arrangements, the second endcap 616 is closed. The filter cartridge 606 is received over a standpipe 618 when the filter cartridge is in the operating or installed position (as shown in FIG. 6).

Similar to the filter cartridge 104, the filter cartridge 606 includes a removable screen assembly 620. The screen assembly 620 includes a screen portion 622. The screen portion 622 includes a hydrophobic screen. The screen portion 622 captures, coalesces, and drains water remaining in the fuel after the fuel has been passed through the primary filter element 608. The screen portion 622 is substantially cylindrical in shape such that it can be inserted over the standpipe 618 and inside of the primary filter element 608. Accordingly, the screen portion 622 is positioned on the clean side 612 of the primary filter element 608. The screen assembly 620 is positioned inside of an opening formed within the primary filter element 608, and the standpipe 618 is positioned within an opening formed within the screen assembly 620 when the filter cartridge 606 is in the operating position (i.e., the primary filter element 608, the screen assembly 620, and the standpipe 618 are positioned in a nesting relationship when the filter cartridge 606 is in the operating position).

The screen assembly 620 includes an endcap portion 624. Unlike in the screen assembly 118 of system 100, the screen portion 622 and the endcap portion 624 are integral. The screen assembly 624 is removably received within the filter cartridge 606. The endcap portion 624 is removably received within the second endcap 616. The connection between the endcap portion 624 and the second endcap 616 may be formed by a snap-fit connection, a press-fit connection, a friction-fit connection, or the like. A seal 626 may be positioned between the endcap portion 624 and the second endcap 616 to seal the dirty side 610 from the clean side 612. The endcap portion 624 includes an enlarged chamber 628 to gather separated air.

Still referring to FIG. 6, the filtration system 600 includes a valve 630. The valve 630 is a no-filter no-run valve. The valve 630 is positioned on an end of the standpipe 618. The valve 630 includes a ball 632 that is biased towards an orifice 634 of the valve 630. The ball 632 is sized and shaped to seal the orifice 634. Accordingly, the valve 630 is biased towards the closed position (i.e., the ball 632 blocks fluid from flowing through the orifice 634) that prevents the flow of fluid through the valve 630. The orifice 634 leads to a fuel supply line 636 that provides filtered fuel from the filtration system 600 to a component of an internal combustion engine, such as a fuel injector. When the valve is in the closed position, fuel is prevented from flowing from the filter housing to the internal combustion engine. The endcap portion 624 includes a valve interaction pin 638. As shown in FIG. 6, when the filter cartridge 606 is fully inserted in the housing and is in an operating position within the housing, the valve interaction pin 638 pushes the ball 632 away from the orifice 634 thereby opening the valve 630 and allowing fuel to flow through the fuel supply line 636.

Similar to filtration system 100, in filtration system 600, fuel only flows from the housing through the fuel supply line 636 when the valve interaction pin 638 opens the valve 630. The valve interaction pin 638 only opens the valve 630 when the screen assembly 620 is positioned in an operational position within the housing formed by the lower and upper shells 602 and 604. Accordingly, fuel flows when the screen assembly 620 having the valve interaction pin 638 is in the installed position. The screen assembly 620 can only be in the installed position when the screen assembly 620 is installed into the filter cartridge 606, and the filter cartridge 606 is fully installed in the operational position within the housing. Accordingly, the positioning of the valve interaction pin 638 on the screen assembly 620 ensures that both filtration components (the screen assembly 638 and the primary filter element 608) are present. This prevents the internal combustion engine and its components, such as the fuel injectors, from receiving dirty fuel. Further, the multicomponent design of the filtration cartridge 606 having the separable primary filter element 608 and screen assembly 620 helps ensure that the appropriate filter cartridge components are used during service operations. If an improper component is used, fuel may not flow from the filtration system 600 to the internal combustion engine, thereby preventing potentially dirty fuel from entering the internal combustion engine.

Further, the screen assembly 620 may have a different lifespan than the primary filter element 608. Because the screen assembly 620 is a separate, stand-alone unit, the screen assembly 620 and the primary filter element 108 can be replaced independent of each other. For example, if the screen assembly 620 is designed to have a longer filtering lifespan than the primary filter element 608, an operator of the internal combustion engine can independently replace the primary filter element 608 multiple times before having to replace the screen assembly 620. Such an arrangement reduces the costs of replacement parts because customers only need to purchase one of the screen assembly 620 and the primary filter element 608, not both at the same time in arrangements where the screen assembly 620 and the primary filter element 608 are integrated. Additionally, such an arrangement reduces unnecessary waste as both the primary filter element 608 and the screen assembly 620 can each be independently replaced based on their individual filtering capacities (e.g., their individual maximum contamination levels).

The above described filtration systems and filter cartridge arrangements are described in the context of fuel filters. However, similar concepts may be applied to other liquid filtering systems. For example, similar filtration systems may be applied to lubricant filtration systems, hydraulic fluid filtration systems, and the like.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

1. A filtration system for filtering a fluid and providing the filtered fluid to a component of an internal combustion engine, the filtration system comprising:
a housing;
a standpipe having a valve, the valve being biased towards a closed position that prevents the flow of fluid through the valve;
a filter cartridge removably received within the housing, the filter cartridge includes a primary filter element and a screen assembly;
the primary filter element including a filter media for filtering the fluid, a first endcap, and a second endcap, the second endcap being an open endcap; and
the screen assembly including a screen portion and an endcap portion, the endcap portion including a valve interaction pin that interacts with the valve to open the valve and allow the fluid to flow through the valve when the filter cartridge is in an operating position within the housing, the endcap portion removably connected to the second endcap of the primary filter element such that the endcap portion and the second endcap seal a clean side of the filter media from a dirty side of the filter media.

2. The filtration system of claim 1, wherein the valve includes a ball and an orifice, the ball being biased towards the orifice.

3. The filtration system of claim 2, wherein the ball is sized and shaped to seal the orifice.

4. The filtration system of claim 2, wherein the orifice is connected to a fluid supply line of the standpipe, the fluid supply line providing the filtered fluid to the component.

5. The filtration system of claim 2, wherein the valve interaction pin extends through the orifice and pushes the ball away from the orifice when the filter cartridge is inserted into the housing in the operating position.

6. The filtration system of claim 5, wherein the valve interaction pin is hollow and includes a passage there through, wherein a tip portion configured to extend into an opening within the standpipe that leads back to the fuel tank, wherein the passage allows air trapped in the housing to be vented from the housing through the valve interaction pin.

7. The filtration system of claim 1, wherein the endcap portion is removably connected to the second endcap such that the primary filter element and the screen assembly are independently replaceable.

8. The filtration system of claim 1, wherein the screen assembly is positioned inside of a first opening formed within the primary filter element.

9. The filtration system of claim 8, wherein the standpipe extends inside of a second opening formed within the screen assembly.

10. The filtration system of claim 1, wherein the screen assembly has a longer filtering lifespan than the primary filter element.

11. The filtration system of claim 1, wherein the screen portion and the endcap portion are an integral component.

12. The filtration system of claim 1, wherein the screen portion and the endcap portion are connected through a snap-fit connection.

13. The filtration system of claim 1, wherein the first endcap is an open endcap.

14. (canceled)

15. The filtration system of claim 1, wherein the fluid is fuel and the component is a fuel injector.
